(19) United States
(12) Patent Application Publication
(10) Pub. No.: US 2003/0138121 A1
(43) Pub. Date: Jul. 24, 2003

(54) Ultrasonic converter unit having electrodes made of electrically-conductive plastic

(76) Inventors: Siegfried Reck, Nienburg (DE); Thomas Siebenhaar, Redwitz (DE)

Correspondence Address: Walter Ottesen, Patent Attorney, P.O. Box 4026, Gaithersburg, MD, 20885-4026, US

(21) Appl. No.: 10/347,315

(22) Filed: Jan. 21, 2003

(30) Foreign Application Priority Data
Jan. 18, 2002 (DE) 102 01 873.1

(51) Int. Cl. H04R 25/00

(52) U.S. Cl. 381/190

(57) ABSTRACT

An ultrasonic converter unit (10) includes a disc-shaped piezo-ceramic element (11) which is provided on its upper side with a λ/4 adaptation body (13) and with an attenuating mass (14) and a decoupling layer (17) on the lower side. To avoid conducting leads and the problems associated therewith, the plastic parts (13, 14, 17), which surround the piezo-ceramic oscillator (11), are made electrically conductive and are used for direct contacting of the piezo-ceramic element (11). The adaptation body (13) preferably comprises metallized micro glass balls which are mixed with the synthetic resin. The attenuating mass (14) and the decoupling layer (17) can be made to have low resistance by adding conductive carbon black and function as electric contacts. With the addition of ferromagnetic particles, the shielding attenuation against magnetic alternating fields is improved.

### BACKGROUND OF THE INVENTION

An ultrasonic converter unit having a disc-shaped piezo-ceramic element is known. The top side of the piezo-ceramic element is provided with a λ/4 adaptation body and the lower side is provided with a damping mass and a decoupling layer. The piezo-ceramic element is excited by voltage pulses (a single pulse or a group of pulses) to oscillations of high frequency. The thickness of the piezo-ceramic element determines the natural frequency of the oscillator and the ratio between the periphery and the thickness of the converter disc determines the radiation characteristic.

The acoustic impedance of the piezo-ceramic element lies about 10⁵ higher than the impedance of the air at ambient pressure. Without a suitable adaptation, the sound waves within the piezo-ceramic element would be almost completely reflected at the boundary layer to air and only a fraction of the sonic power would be transmitted to the air. For this reason, ultrasonic converters have a so-called adaptation layer which is often configured as a pot or cup. In order to obtain a power adaptation and therefore an optimal signal transmission, the thickness of the adaptation layer must amount to precisely a quarter of the wavelength. Furthermore, the acoustic impedance of the material used has to correspond to the geometric mean from the impedances of the air and the piezo ceramic.

FIG. 2 of the drawings herein schematically shows the assembly of ultrasonic unit 20 according to the state of the art. In this connection, reference can be made to German patent publications 198 11 982 and 40 28 315.

The oscillator 21 of the ultrasonic converter unit 20 is a thin disc made of piezo ceramic and conductively coated on both sides. The electrical connection of the oscillator 21 takes place via copper leads (22a, 22b) which are soldered to contact layers (23a, 23b) of the piezo-ceramic element 21, respectively. After soldering, the piezo-ceramic element 21 is glued to the base of a plastic pot 24 which serves as an adaptation body. Thereafter, the pot 24 is filled with a damping mass 25 which absorbs the sonic energy radiated to the opening of the pot. The adaptation pot 24 is embedded in a soft plastic mass 26 in order to prevent the transmission of structure-borne sound during the assembly of the sonic converter 20.

As a practical matter, the requirement with reference to the acoustic impedance of the adaptation material and the requirements as to strength and overall resistance cannot be simultaneously satisfied. A compromise is provided by an adaptation layer 24 of epoxy resin which is mixed with such a high component of micro glass hollow balls that neighboring balls contact each other. The synthetic resin ensures the strength and the hollow balls reduce the specific weight and therefore the acoustic impedance of the material.

The damping material 25 with which the adaptation pot 24 is filled comprises a plastic which is mixed with corundum particles which reduce sonic energy via friction. The casting mass 26 for decoupling the structure-borne sound is likewise a plastic.

The assembly of the above-described ultrasonic converter 20 takes place substantially manually because of the complex work steps. A significant disadvantage is the soldering of the connecting leads (22a, 22b) to the respective contact surfaces (23a, 23b) of the piezo-ceramic element 21. It is also a disadvantage that the adaptation pot 24 has to have a recess 27 which accommodates one of the solder positions (namely, solder position 28a) of the solder positions (28a, 28b). During assembly, the piezo-ceramic element 21 must be correspondingly aligned. The manipulation of the wired ceramic platelet 21 is problematic because it can develop fractures or break already in response to a slight bending load of the connecting leads (28a, 28b). Damage to the ceramic element 21, which is not noticed by a visual inspection, can only be detected with an electrical test at the end of the assembly of the converter 20.

The sonic converters 20 are mostly used as transmission/receiving units. The source impedance of the piezo-ceramic element 21 is very high so that the downstream amplifier stage must have a high input impedance. This makes the input stage of the receiver sensitive with respect to the in-coupling of electric disturbance fields. To prevent this, the sonic converter 20 is, as a rule, surrounded with a suitable screening (for example, shielding sheet metal).

### SUMMARY OF THE INVENTION

The ultrasonic converter unit of the invention includes: a disc-shaped piezo-ceramic element having an upper side and a lower side; a λ/4 adaptation body provided on the upper side; a damping mass and a decoupling layer provided on the lower side; and, the decoupling layer and at least one of the λ/4 adaptation body and the damping mass being made of electrically conducting plastic.

The plastics, which surround the piezo-ceramic oscillator, are electrically conductive and are used for directly contacting the piezo-ceramic element. The material of the adaptation pot, the damping mass and the mass for decoupling the structure-borne sound (decoupling mass) are made to have low ohmage by the addition of conductive particles and serve as electrical contacts.

In order to make the material of the adaptation body conductive, the micro glass hollow spheres are metallized before they are mixed with the synthetic resin. The more balls in the mixture that contact each other, the more current paths result and the more does the specific resistance of the material drop.

The damping material and the material for decoupling the structure-borne sound are made electrically conductive by adding conductive carbon black (with a large surface and high dibutyl phthalate adsorption).

Even with a high concentration of conductive particles, the specific resistance of electrically conductive plastics remains significantly higher than that of metal. With the contacting of the piezo-ceramic element via conductive plastics in accordance with the invention, the ohmic resistance of the feed increases as a consequence thereof. Practical experiments with conventional ultrasonic converters have, however, shown that a longitudinal resistance of approximately 200 ohms in the supply line has only a slight effect on the signal quality of the converter.

The significant advantage of the ultrasonic converter unit of the invention is that the manual soldering of connecting leads to the piezo-ceramic element is unnecessary. This simplifies the assembly considerably and opens up the possibility of an automatic manufacture of the sonic converter unit.

The connection between the converter and the downstream electronic circuits is simplified by the direct connection of the converter element to the printed circuit board because manual soldering is unnecessary also at this interface.

A shielding action against electric fields is provided because of the relatively low specific resistance of the materials which surround the piezo oscillator. The conductive plastics shield also against high frequency magnetic alternating fields. The shielding attenuation of the materials used can be further increased by the addition of ferromagnetic particles. A separate shielding sheet metal can be omitted.

### BRIEF DESCRIPTION OF THE DRAWINGS

The invention will now be described with reference to the drawings wherein:

FIG. 1 is a longitudinal section view of the ultrasonic converter unit according to the invention; and,

FIG. 2 is a longitudinal section through an ultrasonic converter unit as known from the prior art.

### DESCRIPTION OF THE PREFERRED EMBODIMENTS OF THE INVENTION

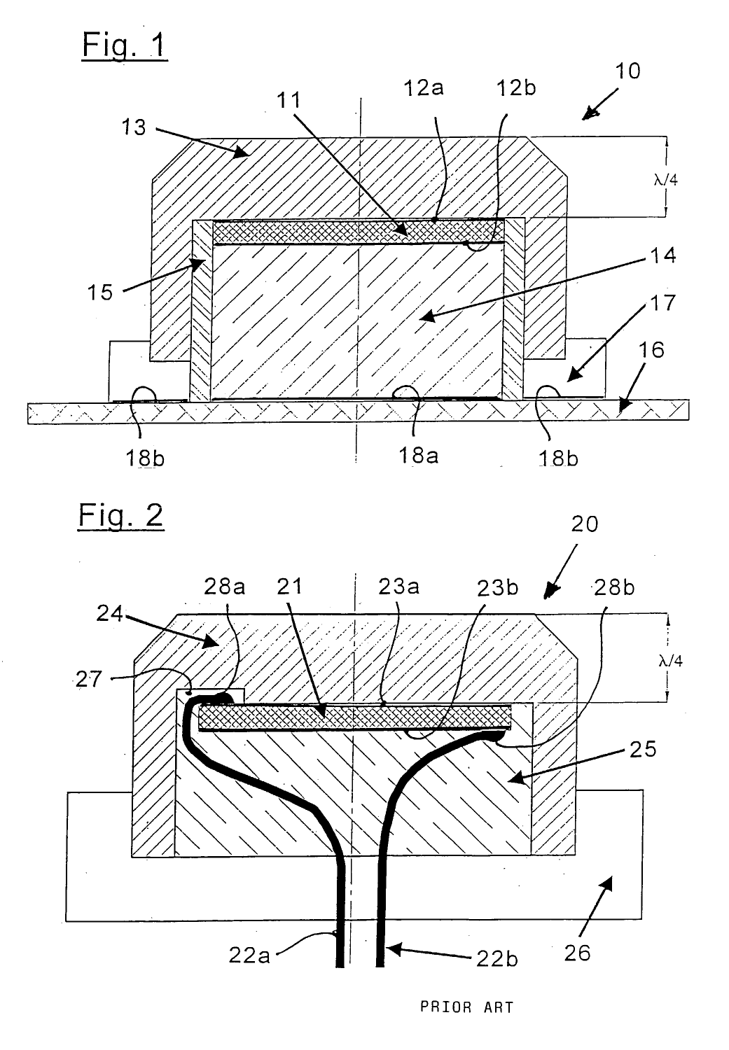

The core piece of the ultrasonic converter unit 10 shown in FIG. 1 is a disc-shaped piezo-ceramic element 11 which has metal contact layers with contact surfaces (12a, 12b) on both sides. One (namely, the contact surface 12a) of the contact surfaces (12a, 12b) is glued to the base of a pot-shaped electrically-conductive adapter body 13. This contact surface 12a is glued using a conductive adhesive. The thickness of the adaptation layer 13 amounts to one quarter wavelength (λ/4) of the ultrasonic signals to be used. The acoustic impedance of the adaptation layer 13 corresponds to the geometric mean of the acoustic impedances of the surrounding medium (air) and the piezo ceramic. An electrically conductive attenuating mass 14 is glued to the other contact surface 12b of the contact surfaces (12a, 12b).

An insulating layer 15 is disposed between the wall of the adaptation cup 13 and the electrically-conductive attenuating mass 14. The insulating layer 15 separates the two current paths to the connecting surfaces (12a, 12b) of the piezo-ceramic element 11.

A plastic layer 17 for decoupling the structure-borne noise is disposed between the adaptation pot 13 and a carrier plate 16. The plastic layer 17 is likewise made of conductive material. The carrier plate 16 has metal contact surfaces (18a, 18b), which are glued to the conductive plastic components (14, 17) of the ultrasonic converter unit 10. The carrier plate 16 is a printed circuit board having an interface for a downstream evaluation circuit (not shown).

It is understood that the foregoing description is that of the preferred embodiments of the invention and that various changes and modifications may be made thereto without departing from the spirit and scope of the invention as defined in the appended claims.

What is claimed is:

1. An ultrasonic converter unit comprising:
a disc-shaped piezo-ceramic element having an upper side and a lower side;
a λ/4 adaptation body provided on said upper side;
a damping mass and a decoupling layer provided on said lower side; and,
said decoupling layer and at least one of said λ/4 adaptation body and said damping mass being made of electrically conducting plastic.

2. The ultrasonic converter unit of claim 1, wherein said λ/4 adaptation body comprises metallized micro glass balls which are mixed with synthetic resin or plastic.

3. The ultrasonic converter unit of claim 1, wherein said damping mass and said decoupling layer are made electrically conductive by adding conductive carbon black.

4. The ultrasonic converter unit of claim 1, wherein said λ/4 adaptation body has a cup-like shape.

5. The ultrasonic converter unit of claim 4, wherein said cup-shaped adaptation body has a cylindrical inner wall surface; and, said ultrasonic converter unit further comprising an insulating layer disposed between said cylindrical inner wall surface on the one hand and said piezo-ceramic element and damping mass on the other hand.

6. The ultrasonic converter unit of claim 1, wherein said ferromagnetic particles are added to said damping mass and said decoupling layer which surround said piezo-ceramic element.

7. The ultrasonic converter unit of claim 1, further comprising a carrier plate having metal contact surfaces; and, said damping mass and said decoupling layer being glued to said metal contact surfaces with conductive adhesive.

8. The ultrasonic converter unit of claim 7, wherein said carrier plate is a printed circuit board defining an interface to a downstream evaluation electronic unit.
